(19) United States
(12) Patent Application Publication
(10) Pub. No.: US 2006/0071764 A1
(43) Pub. Date: Apr. 6, 2006

(54) Merge Sensor Control System

(76) Inventor: William D. Lynch, Thornton, CO (US)

Correspondence Address: KYLE W. ROST, 5490 AUTUMN CT., GREENWOOD VILLAGE, CO, 80111, US

(21) Appl. No.: 10/711,539

(22) Filed: Sep. 24, 2004

(51) Int. Cl. B60Q 1/00

(52) U.S. Cl. 340/435; 340/461

(57) ABSTRACT

A land vehicle is equipped with a warning system for improving the safety of lateral merges. A directional signal selector switch actuates the directional signal lights on a selected side of the vehicle. Proximity sensors are mounted on the sides of the vehicle to sense external obstacles. A slave switch works in cooperation with a directional signal selector switch to actuate the proximity sensors on the same side as the actuated directional signal lights. A warning device communicates with the actuated proximity sensors to receive an indication when sensor has sensed an external obstacle and to issue a warning.

### BACKGROUND OF THE INVENTION

1. Field of the Invention

The invention generally relates to electrical communications and to communications using directive wave systems. More specifically, the invention relates to land vehicle alarms or indicators, especially to indicators of relative distance to an obstacle. The invention provides warning of collision or contact with an external object. In another perspective, the invention is a warning device and a system for actuating the device by the presence of a land vehicle.

2. Description of Related Art Including Information Disclosed Under 37 CFR 1.97 and 1.98

Distance sensing systems provide assistance in approximating the relative positions of two objects. One example is radar, which transmits a known energy wave and then receives back its reflection from a detected object. A simple automated calculation determines the distance to the detected object. Another example is sonar waves used in bodies of water to locate ships. Similar technology enables fish finders to assist fishermen in locating their underwater prey. Cameras often carry automatic focus systems that are sufficiently accurate to produce reasonably focused photographs. Commonly, these cameras employ infrared light waves to measure the distance between the camera and a subject. Systems such as these employ diverse parts of the energy spectrum. The chosen waves might be called radio waves, magnetic waves, sound waves, light waves, microwaves, or still other specific names given to specific portions of the energy spectrum. Known technologies enable these various waves to perform locating or measuring functions within appropriate environments.

Many forms of energy waves are present in ambient environments. Some are considered safer than others for humans to endure. Two general approaches to safety issues are to employ energy types that are considered safe or benign and to actuate energy waves only when needed. An example showing both approaches to safety is the use of infrared waves in auto focus cameras. On one hand, infrared light is considered to be quite safe. On the other hand, the auto focus function is actuated only briefly, just before the camera shutter is actuated. Sound waves also are considered safe, to the extent they are used in various types of medical imaging such as ultrasound imaging. The length of exposure is limited to the necessary period for capturing the images.

The automobile industry has used ultrasonic signals in backup sensors, typically actuated when a car is placed in reverse gear. Early backup sensors signaled the closeness of a target object to the rear of a car by a Doppler type of audible signal: an audible tone pulsated with increasing frequency as the distance to a target object decreased. Improved versions fed the distance data to a graphic screen that produced a visual display, schematically showing the distance between the car and the detected obstacle. The use of screens enabled a digital readout of distance, and a voice distance indicator was added to orally inform the driver of the distance. The backup sensor now has been coupled or supplemented with an inexpensive, low-resolution camera located on the rear of a car, displaying the rearward image on a suitable dashboard screen. Rear end cameras have been used for a considerable time on buses and similarly large mobile homes as a backing-up aid. However, the coupling of a video camera with backup sensors offers a newly helpful combination for both displaying nearby objects and signaling their distance.

Technologies such as the various types of backup sensor offer improved safety and assist the driver in avoiding property damage. It would be desirable to improve and employ these technologies to achieve higher levels of safety and damage prevention.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide a system for altering a driver to potential collision or contact with another vehicle during merges.

According to the invention, a proximity sensor control system selectively and automatically actuates a proximity sensor to detect and warn of a hazardous lateral proximity between a land vehicle in forward motion and an external obstacle, so as to improve the safety of lateral merges. The system is adapted for use with a land vehicle equipped with a directional signal light on a lateral side of the land vehicle. A directional signal selector switch selectively directs a current source to power the directional signal light. The sensor control system provides a selectively actuatable proximity sensor capable of sensing an external obstacle and sending a responsive signal. The sensor can be mounted to the land vehicle in a laterally disposed position suitable for sensing external obstacles on a lateral side of the land vehicle. A slave switch actuates the proximity sensor. The slave switch communicates with the directional signal selector switch to actuate the proximity sensor when the directional signal selector switch actuates the directional signal light. A warning device communicates with the proximity sensor to receive an indication of the responsive signal and to issue a warning that the sensor has sensed an external obstacle.

In further detail, the slave switch has an input for connection with the current source to supply non-intermittent current to the slave switch. The slave switch also has an output connected to the proximity sensor, supplying non-intermittent current to the proximity sensor.

The proximity sensor may be an array of at least four proximity sensors arranged into a right side group and a left side group. The right side group includes first and second sensors mounted in positions sensing to the right of said land vehicle, and the left side group includes first and second sensors mounted in positions sensing to the left of the land vehicle. The first sensor of each group is mounted in a laterally directed position, and the second sensor of each group is mounted in a position directed partially rearwardly. The right and left side groups each may include a third sensor directed partially forward.

In additional detail, the land vehicle is equipped with a source of pulsed current cycles separated by a gap. The pulsed current powers the directional signal light to operate in a blinking mode. The slave switch can be embodied as a controller connected to a source of relatively constant current and to the source of pulsed current cycles. The controller includes a timer that measures a selected period of time. The controller is structured to trigger operation of the proximity sensor when it receives a current pulse. Then the controller supplies relatively constant current to the proximity sensor over a selected time period measured by the timer. The timer is structured to restart when the controller receives a current pulse from the source of pulsed current cycles. The selected time period equals or exceeds the period of a pulsed current cycle. As a result, the timer causes the controller to supply constant current to the proximity sensor through the gap between current pulses.

According to another aspect of the invention, the land vehicle carries both a right side proximity sensor and a left side proximity sensor. A slave switch communicates with the directional signal selector switch to actuate which ever of the right or the left side proximity sensors is on the same side of the vehicle selected by the directional signal selector switch. A warning means communicates with the actuated proximity sensor on the selected side to receive an indication of the responsive signal and issue a warning that the actuated proximity sensor has sensed an external obstacle.

According to a further aspect of the invention, a proximity sensor control system in a land vehicle selects and actuates a proximity sensor on a selected side of the land vehicle to detect and warn of a hazardous lateral proximity between the land vehicle in forward motion and an external obstacle, so as to improve the safety of lateral merges. The land vehicle is equipped with right and left side directional signal lights respectively on right and left sides of the land vehicle. A directional signal selector switch is arranged to select the right or left side directional signal lights. The vehicle also provides a source of relatively constant current and a source of intermittent current. A right side proximity sensor is located on the right side of the land vehicle. A left side proximity sensor is located on the left side of the land vehicle. The directional signal selector switch is connected to the source of relatively constant current and to the source of intermittent current and is moveable from a neutral position to either a first selection position or a second selection position. The directional signal selector switch is connected to the right side proximity sensor such that when the directional signal selector switch is in the first selection position, the intermittent current source is connected to the directional signal lights on the right side of the vehicle, and the relatively constant current source is connected to the proximity sensor on the right side of the vehicle, actuating the right side sensor. The directional signal selector switch is connected to said left side proximity sensor such that when the directional signal selector switch is in the second selection position, the intermittent current source is connected to the directional signal lights on the left side of the vehicle, and the relatively constant current source is connected to the proximity sensor on the left side of the vehicle, actuating the left side sensor.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a schematic diagram showing one embodiment of actuation circuitry for the merge sensor system.

FIG. 2 is a schematic diagram showing a second embodiment of actuation circuitry for the merge sensor system.

FIG. 3 is a schematic diagram showing warning circuitry for the merge sensor system.

### DETAILED DESCRIPTION OF THE INVENTION

The invention is an apparatus and method for controlling a system of sensors for use on a car, truck, bus, or other land vehicle. The sensor system is especially useful on a subject vehicle that travels on a multilane roadway where periodically the subject vehicle must merge into a neighboring lane. The sensor system is especially adapted to operate while the subject vehicle is traveling in forward motion, often at highway speed, to detect and warn of a hazardous proximity between the subject vehicle and an external obstacle. Most commonly, the external obstacle is another vehicle traveling in the same direction, in a neighboring lane. One of the primary utilities of the invention is to warn of the presence of a vehicle in a neighboring lane, having too close a proximity for the subject vehicle to merge safely into the neighboring lane.

A desirable feature is that the sensor system can be operated to potentially give a warning signal only at selected times, such as when the driver of the subject vehicle selects to have the sensors operate. The invention is adapted to interact with a directional signal system on the subject vehicle, which is a feature found on substantially every highway vehicle manufactured for many years. In one embodiment, the invention is configured as a kit or aftermarket product that can be installed on a previously manufactured vehicle to cooperate with the pre-existing directional signal system. In a second embodiment, the invention is integrated into the electrical system of a vehicle in an arrangement suited for inclusion during original design and manufacture of the vehicle.

The sensor system operates selectively and specifically. The system is actuated by selective means such as the directional signal selector switch. In this way, the driver of the subject vehicle is allowed to select if and when the sensor system will operate. Safe driving practices favor the use of a directional signal light when merging. Thus, the actuation of a directional signal light also simultaneously actuates the sensor system to read whether there is sufficient space in a neighboring lane for a merger to take place, safely. The sensor system is specific in operation by sensing toward the intended direction of merger, as indicated by the appropriate actuation of either right or left directional signal.

Consequently, the system operates seamlessly with normal prior safe driving practices and requires no new or different actions by the driver. At the same time, the system can be limited in operation to those times when needed, when merger is imminent as indicated by actuation of a directional signal. At other times, the sensor can be allowed to remain in deactivated mode by allowing the directional signal selector switch to remain in neutral position, such as when the subject vehicle is not engaged in a signaled lane change merger. In this way, the system reserves its operational warnings for times and driving maneuvers when such warnings are significant.

The drawings illustrate the invention in principle and may show circuitry in abbreviated form. Often commercial circuit arrangement is more complex, such as for operating the front and rear signals in alternate flashing sequence. The schematic arrangements of the drawings provide examples for the purpose of fundamental disclosure. Adaptation to commercial designs and further enhancement is expected.

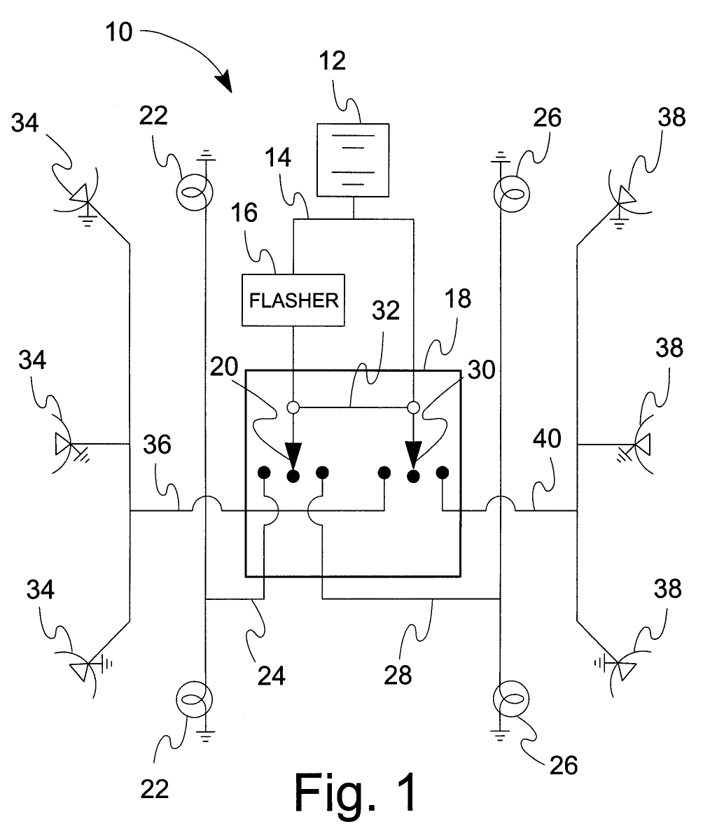

The embodiment of a sensor control system 10 shown in FIG. 1 is representative of an original equipment installation. Here the vehicle battery 12 provides a source of relatively constant current to the sensor control system as well as to many other devices of vehicle equipment. A directional signal system is connected to the battery to supply current to a turn signal circuit 14. A flasher 16 or similarly functioning apparatus provides a source of periodically pulsed current derived from the constant current supply. The pulsed current intermittently flashes the actuated directional signal lights.

A directional signal selector switch 18 is shown within a single schematic box to include on the left hand side of the figure a three-position switch 20. In part, this switch functions as a standard directional signal selector switch that resides in a center, neutral, or deactivated position. The switch can be moved to either side of neutral position to select the right or left side of the vehicle for actuation of signal lights. The directional signal selector switch provides the initial or master selection function. The directional signal selector switch simultaneously selects and actuates turn signal lights on the chosen side of the vehicle. For example, switch 20 can be moved to the left of the orientation of FIG. 1 to select the left side of the vehicle and actuate the left turn signal lights 22 through left output circuit 24. Movement to the right of neutral selects the right side of the vehicle and actuates the right turn signal lights 26 through right output circuit 28.

The flasher 16 operates between the battery 12 and switch 20 to provide a source of intermittent current and to cause the actuated signal lights 22, 26 to operate in a blinking mode. The flasher provides pulsed current cycles, or intermittent pulses separated by a gap, to the signal lights operating through either side of switch 20. One pulsed current cycle includes both the current pulse and a gap until the next pulse arrives. The length of a pulsed current cycle is the sum of the time a signal light is lit plus the time the signal light is unlit during operation.

The flash rate tends to fall within a predictable or readily determinable range. Commonly, the flash rate is close to one and one-half flashes per second or about ninety flashes per minute. A signal light is lit over about one-half the pulsed current cycle. Taking into account that different producers might vary this rate and different flasher unit samples might vary in individual characteristics, a useful approximation of flash rate might range from one to two flashes per second or from sixty to one hundred twenty flashes per minute. A single current pulse may last from one-half to one second, with an average of about two-thirds of a second. A determination of these factors is useful in arranging a suitable circuitry to operate sensor system 10. The circuitry to operate sensors within system 10 could share the directional signal circuitry 14 if the length of a current pulse cycle is sufficient to operate the sensors.

The embodiment of FIG. 1 shows a parallel sensor circuitry 28 that provides a continuous sensor current not interrupted by the flasher. Directional signal selector switch 18 includes on the right hand side of the figure a three-position switch 30 that operates as a slave switch to the movement of master switch 20. For example, a mechanical link 32 or other coordinating device may cause the two switches 20 and 30 to operate in unison in the selection of the right or left side of the vehicle. Both selection functions may be united in a single switch.

The drawing shows slave switch 30 residing in a center, neutral, or deactivated position. Like switch 20, slave switch 30 can be moved to either side of neutral position to select a side of the vehicle and actuate sensors on the selected side. Alternatively, the switch 30 performs the function of selecting specific sensors, such as sensors on a circuit on a single side of the vehicle, and actuates them. Further, because switch 30 operates in slave capacity, it may be viewed that switch 20 performs the selection function, to select the side of the vehicle or the sensors to be actuated, and switch 30 performs the actuation function. For example, switch 30 is moved to the left of neutral position to activate a left side group of sensors 34 through left output circuit 36. Movement to the right of neutral actuates a right side group of sensors 38 through right output circuit 40.

The groups of sensors 34,38 are arranged on the vehicle in suitable positions and in suitable numbers to detect the proximity of other vehicles in neighboring relationship to the subject vehicle. FIG. 1 is schematically arranged with the top of the drawing corresponding to the front of the subject vehicle. The sensors 38 and turn signal lights 26 are arranged on the right side of the subject vehicle, while sensors 34 and turn signal lights 22 are arranged on the left side of the vehicle.

A group of three sensors is shown on each side, one to the front, one in the center, and one to the rear. These sensors may be built into the vehicle at convenient mounting locations. A front sensor may be associated with a front turn signal light array or a front bumper. A rear sensor may be associated with a rear turn signal light array or a rear bumper. A center sensor may be associated with a side running light or doorpost. Each center sensor is shown directed at least partially sideways of the vehicle. The front sensor is shown directed to an angle between the front and side directions, such that the front sensor is aimed with both a front vector component and a sideways vector component. The rear sensor is shown directed to an angle between the rear and side directions, such that the rear sensor is aimed with a rear vector component and a sideways vector component.

The number of sensors per vehicle is determined by need. Two to six sensors typically are needed. Since drivers tend to focus attention toward the front of a vehicle, following the intended path of travel, the front sensors are optional. The center and rear sensors remain desired components of a merger sensing system, although a suitable sensor technology may allow consolidation of function into a single sensor on each side or even a single sensor capable of detecting vehicles in proximity to both sides of the subject vehicle. Thus, a preferred arrangement of sensors includes at least four sensors arranged in right and left pairs and directed sideways and to the rear of the subject vehicle.

The dual switch arrangement shown in schematic box 18 provides an example of a device that enables the automatic activation of the appropriate set of sensors 34 or 38 that corresponds to the actuated directional signals. The proximity sensors 34, 38 may be ultrasonic sensors, emitting an ultrasonic energy wave and detecting the return reflection of the wave. By providing a direct circuit from battery 12 to each actuated sensor, this arrangement enables substantially continuous operation of each actuated sensor for so long as the corresponding directional signals are actuated. Alternatively, the sensors on each side of the vehicle could be controlled in-line with the flasher 16, provided that the operation of the sensors can accommodate an interrupted or pulsing current flow. Considering that a turn signal light is lit for a typical duration of from one-half second to three-quarters second, a sensor capable of becoming actuated and performing its detection function within this period can be operated directly through switch 20.

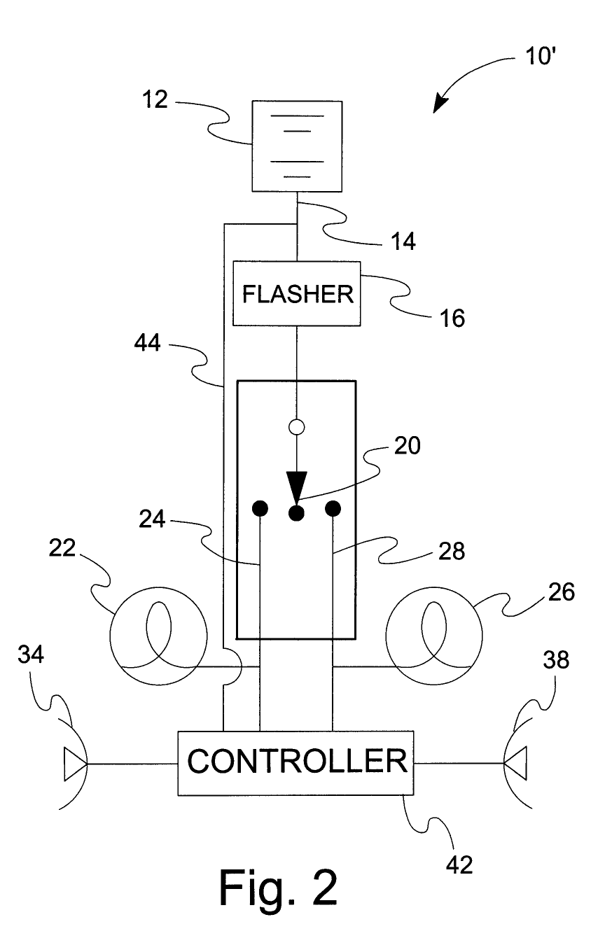

FIG. 2 shows an installed embodiment of a modified sensor control system 10′, suited for installation to a vehicle either during original manufacture or as an aftermarket product. This embodiment shows a representative directional signal system in which the vehicle battery 12 powers the directional signals by a circuit 14 containing a flasher 16 and a directional signal selector switch 20. As previously described, switch 20 selectively actuates either the left or right side turn signal lights 22, 26 through respective output circuits 24, 28.

The battery 12, flasher 16, switch 20, and signal lights 22, 26 are components found on a roadworthy vehicle of modern manufacture regardless of whether the sensor control system 10′ has been installed. Nevertheless, these components become part of an installed sensor control system 10′. Due to their expected prior presence on every vehicle, they need not be included in a kit or packaged system intended for installation.

A kit or package for installation would include a sensor controller with suitable connection points to the vehicle wiring, proximity sensors, and warning output devices. The controller serves as a switching device that electronically performs at least the switching function of switch 30 in FIG. 1. The switching function is in slave capacity when it responds to actuation of the directional signals through switch 20. A sensor controller 42 is connectable to the left and right output circuits 24, 28 from a directional signal selector switch 20. The controller 42 also is connectable to the battery 12 to receive constant current from battery 12 through current input circuit 44. The controller 42 is operatively connected to left side sensor or array of sensors 34 and to the right side sensor or array of sensors 38. The controller 42 may be a solid-state processor that responds to input current through circuits 24 or 28 as signals indicating that a left or right directional signal light has been actuated. In turn, the controller directs current to sensors 34 or 38 on the appropriate side of the subject vehicle to actuate the selected sensors or group of sensors. Constant current line 44 both powers the controller and provides a constant current source for powering the sensors. Thus, the controller serves as a triggering device, responsive to movements of the directional signal selector switch, for supplying substantially constant current to the selected sensors.

The controller 42 includes a timer function. The timer may be set to measure a period that can be expected to exceed a typical pulsed current cycle of a flasher 16. Software or firmware operating the controller 42 may cause the controller to continue providing current to the selected sensors for the measured time period, regardless of whether the triggering pulse ends.

In operation, the directional signal selector switch 20 provides a pulsed signal to the controller to actuate the appropriate side array of sensors. The pulsed signal from the switch 20 is intermittent, followed by a gap that terminates the signal at the end of each current pulse. The controller is programmed to cease operation of the selected sensors when the signal from switch 20 ends, or equivalently, to terminate the command to actuate the proximity sensors, with a delay for the time period until the timer finishes a measurement period. The timer ensures that the sensor array continues to be actuated over a sufficient period to allow a subsequent sequential current pulse within the same operational cycle to reach the controller. Setting the timer to measure a time equal to or exceeding a typical or expected single pulsed current cycle produces this result. During a single operating period of the directional signal system, a next current pulse arrives from switch 20 before the timer has expired, renewing the command to actuate the appropriate proximity sensor array. Each new current pulse also resets the timer to restart the measurement period.

At such time as the directional signal selector switch is returned to neutral position, the signal from switch 20 ceases. Then, without a fresh signal arriving from switch 20, the timer will expire without reset. The controller 42 will be allowed to respond by shutting off current to the selected proximity sensors and ending one session of operating the proximity sensors.

The timer can be preset to a period slightly exceeding the known or expected length of a flasher cycle, such as one-half to one second. Thus, a timer period may be set as one or more seconds, which easily covers the expected period of signal interruption. The manufacturer of a vehicle that includes the controller 42 may preset the timer period to the known or anticipated flasher cycle period. In vehicles having on-board processor control of suitable functions, the correlation of pulse current cycle and timer period may fall under software coordination. Alternatively, the functions of controller 42 are incorporated into another on-board processor having additional functions.

The controller 42 may offer a calibration and learning mode. While the controller is in learning mode, the directional signals may be actuated over a calibration period. During this period, the controller measures the pulse current cycle or flasher rate and resets the timer accordingly, such as to a multiple of the measured cycle period. The learning mode allows the controller to adapt to changes due to component replacement or component aging. The learning mode is useful in an aftermarket sensor control system to adapt the system to the pulse current cycle of any vehicle.

A preferred method of setting the time measurement period is for the controller to measure the length of one or more recent current pulses in real time and to reset the timer accordingly. Thus, the controller may reset the timer measurement period to twice or more the recent average pulse lengths. The controller may maintain a lookup table of recent measurements to provide a starting measurement period or to provide a running average for any periodic update to the measurement period. First and last pulses may be eliminated from a lookup table to remove possible clipped pulses from calculations.

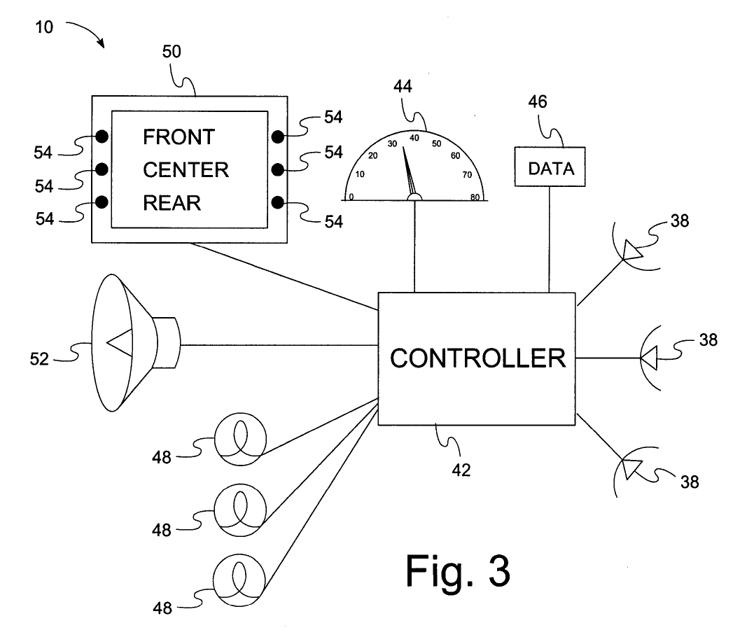

A programmed controller 42 or other microprocessor provides numerous beneficial methods of operating the system of sensors. After the sensors have been appropriately actuated and operated to gather proximity data, the sensor system must report the data in a useful way. In any of the previously described embodiments 10, 10′, the various sensors are connected at least on their output side to a controller 42. Thus, a controller 42 or other processor of similar capability receives sensed data and produces a warning signal when appropriate. For purposes of description, FIG. 3 shows the controller 42 connected to a representative array of sensors 38, represented as the right side array of sensors 38. The left side array would be equivalently connected to the controller 42.

The sensors communicate sensed proximity data to the controller 42, which optionally combines the proximity data with additional data that may be available to the controller 42. For example, real time readout 44 of vehicle speed may deactivate the automatic operation of the proximity sensor system if speed falls below a pre-defined threshold. As an example, a speed below twenty miles per hour or some other low speed may suggest that the vehicle is turning a corner or parked rather than merging into traffic, and proximity readings are not needed or useful. Speedometer data may permit the controller 42 to automatically adjust a distance setting of each sensor, such as to read further away with increasing vehicle speed. Depending upon what other data is available, the data readout 46 can provide information about ambient weather conditions, time of day or night, steering wheel position, brake application, or other factors. The gathered proximity data is considered according to programmed instructions in combination with any additional data available to the controller.

The controller 42 supplies the gathered information to the vehicle driver in various processed forms. One form is by a visual warning indicator such as a dashboard light or series of lights shown as three lights 48. These lights may warn that a corresponding sensor has sensed an external object. In this example, the top, center, and bottom lights 48 may react respectively to front, center, and rear sensors. Alternatively, the lighting of one, two, or three lights may indicate urgency or danger level, reflecting the relative distance or closeness of the sensed obstruction.

A video screen 50 provides another visual warning indicator. This screen may provide three lines of text readout for providing sensed information. For example, the three lines, respectively, may correspond to the readings of the front, center, and rear sensors. As known in prior applications, the sensors may provide accurate distance or separation readouts. Video screen 50 enables the readout from each sensor to be printed on the corresponding appropriate line of the screen.

Another form for reporting data is an audio readout-warning device representatively shown as a speaker 52. The controller may be programmed to transmit a buzzer or alarm sound in case of a sensed obstacle that is determined to be dangerously near. Alternatively, the speaker may transmit detected distance to a sensed object by synthetic voice response.

A variety of controls 54 may be located on the screen 50 or elsewhere. These controls permit selective operation of the proximity sensor system through controller 42. The illustrated controls 54 are arranged in two columns of three rows, similar to the layout of the three-line screen. One utility for the controls is to provide a manual means to activate or deactivate each of the sensors, with each of six sensors being controlled or adjusted by the control button in corresponding position. Each button 54 can cause the controller to actuate a single selected proximity sensor for obtaining a proximity spot reading, regardless of whether the directional signal system is actuated. Another use is to set a volume level or select a sound characteristic for each sensor, such that the driver is informed where the obstacle is positioned by a distinguishing sound or volume. The controls also may cause the controller to adjust the sensitivity of each sensor. By the use of controls 54, the vehicle operator can adjust the proximity sensor system for customized operation and reporting.

The described embodiments enable the invention to be installed as an aftermarket kit, especially as shown in FIGS. 2 and 3. The controller may provide input wires to be attached or spliced to existing circuitry of the vehicle. For example, the constant current lead 44 is suited for connection to a battery 12 or other circuit location serving as a source of constant current from the battery 12. The controller also is connectable to the leads 24, 28 between switch 20 and the appropriate turn signal lights 22, 26 to acquire right or left automatic actuation signals from the a directional signal system. The groups of sensors 34, 38 are carried on a suitable harness or wiring for connecting to the controller 42. Clips, brackets, adhesives, and the like can attach these sensors to the vehicle in appropriate external positions.

In an aftermarket kit, the controller is connected to output warning devices that can be carried inside the vehicle, as especially shown in FIG. 3. Lights 48, buzzer or speaker 52, and display screen 50, or any of them are suitable examples of includable warning devices. In a preferred arrangement, the controller and warning devices are combined in a single unit that is connected through wires to the battery, directional signal system, and external proximity sensors. The display screen 50 may provide for the unified mounting of all other warning devices and the controller. For example, lights 48 can be mounted in the screen bezel, similarly to one set of control knobs 54. The speaker or buzzer 52 also can be mounted in the screen bezel. The controller, itself, can be mounted in a common housing with the screen. This unified mounting allows a consolidation of interconnection cables to enable efficient installation.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A proximity sensor control system for selectively and automatically actuating a proximity sensor to detect and warn of a hazardous lateral proximity between a land vehicle in forward motion and an external obstacle so as to improve the safety of lateral merges, wherein the system is adapted for use with a land vehicle equipped with a directional signal light on a lateral side of the land vehicle, a current source, and a directional signal selector switch operable to selectively direct the current source to power the directional signal light, wherein the sensor control system comprises:
a selectively actuatable proximity sensor capable of sensing an external obstacle and sending a responsive signal, in use mountable to said land vehicle in a laterally disposed position suitable for sensing external obstacles on a lateral side of the land vehicle, relative to the direction of forward motion;
a slave switching means for actuating said proximity sensor, connectable in communication with said directional signal selector switch to actuate said proximity sensor in response to the directional signal selector switch actuating said directional signal light; and
a warning means for communicating with said proximity sensor to receive an indication of said responsive signal and issuing a warning that the sensor has sensed an external obstacle.

2. The proximity sensor control system according to claim 1, wherein said slave switching means further comprises:
an input for connection with said current source to supply non-intermittent current to the slave switching means; and
an output connected to said proximity sensor, supplying non-intermittent current to the proximity sensor.

3. The proximity sensor control system according to claim 1, wherein said proximity sensor comprises:
an array of at least four proximity sensors arranged into at least a right side group and a left side group, wherein said right side group includes at least first and second sensors mountable in positions sensing to the right of said land vehicle, and said left side group includes at least first and second sensors mountable in positions sensing to the left of the land vehicle, wherein at least said first sensor of each group is mountable in a position directed substantially laterally, and at least said second sensor of each group is mountable in a position directed at least partially rearwardly, relative to the direction of forward motion.

4. The proximity sensor control system according to claim 3, wherein:
each of said right and left side groups of proximity sensors further comprises at least a respective third sensor, wherein said third sensor is mountable in a position directed at least partially forwardly relative to a direction of motion.

5. The proximity sensor control system according to claim 1, further adapted for use with a land vehicle having a source of pulsed current cycles separated by a gap, communicated to said directional signal light for operating the directional signal light in a blinking mode, and having a source of relatively constant current, wherein said slave switching means comprises:
a controller connectable to said source of relatively constant current and to said source of pulsed current cycles and having a timer for measuring a selected period of time;
wherein said controller is structured to trigger operation of said proximity sensor upon receipt of a current pulse from said source of pulsed current cycles and to supply relatively constant current to the proximity sensor over said selected period measured by said timer;
the timer is structured to restart when the controller receives a current pulse from said source of pulsed current cycles; and
said selected period of time is at least equal to the period of a pulsed current cycle, whereby the timer causes the controller to supply constant current to the proximity sensor through the gap between current pulses.

6. A proximity sensor control system in a land vehicle for selecting and actuating a proximity sensor to detect and warn of a hazardous lateral proximity between said land vehicle in forward motion and an external obstacle so as to improve the safety of lateral merges, wherein the land vehicle is equipped with right and left directional signal lights respectively on right and left sides of the land vehicle, a directional signal selector switch selecting a directional signal light on the right or left side for operation, and a current source powering said signal light on the selected side, wherein the sensor control system comprises:
a right side proximity sensor and a left side proximity sensor mounted on the land vehicle;
a slave switching means connected for cooperative operation with said directional signal selector switch for actuating said proximity sensor on the same side selected by the directional signal selector switch; and
a warning means communicating with said actuated proximity sensor for receiving said responsive signal and issuing a warning that the actuated proximity sensor has sensed an external obstacle.

7. The proximity sensor control system according to claim 6, wherein said slave switching means further comprises:
an input for connection with said current source supplying non-intermittent current to the slave switching means; and
an output connected to said actuated proximity sensor, supplying non-intermittent current to the actuated proximity sensor.

8. The proximity sensor control system according to claim 6, wherein said proximity sensor comprises:
an array of at least four proximity sensors arranged into at least a right side group and a left side group, wherein said right side group includes at least first and second sensors mounted in positions sensing to the right of said land vehicle, and said left side group includes at least first and second sensors mounted in positions sensing to the left of the land vehicle, wherein at least said first sensor of each group is mounted in a position directed substantially laterally and at least said second sensor of each group is mounted in a position directed at least partially rearwardly relative to the direction of forward motion.

9. The proximity sensor control system according to claim 8, wherein:
each of said right and left side groups of proximity sensors further comprises at least a respective third sensor, wherein said third sensor is mounted in a position directed at least partially forwardly relative to the direction of motion.

10. The proximity sensor control system according to claim 6, further adapted for use in a land vehicle providing a source of pulsed current cycles separated by a gap, communicated to said directional signal light on a selected side for operating the directional signal light in a blinking mode, and having a source of relatively constant current, wherein said slave switching means comprises:
a controller connected to said source of relatively constant current and to said source of pulsed current cycles, and having a timer measuring a selected period of time;
wherein said controller is structured to actuate the right or left side proximity sensor, in accordance with the side selected by said directional signal selector switch, upon receipt of a current pulse from said source of pulsed current cycles and to supply relatively constant current to the selected proximity sensor on said selected side over said selected time period measured by said timer;
the timer is structured to restart when the controller receives a current pulse from said source of pulsed current cycles; and
said selected period of time is sufficient that the controller supplies constant current to the proximity sensor on the selected side through the gap between current pulses.

11. The proximity sensor control system according to claim 6, further comprising:
a flasher connected to said current source and to said directional signal selector switch, supplying intermittent current pulses to said selected directional signal light; and
wherein said slave switching means is connected to said current source to supply a non-intermittent current to said actuated proximity sensor.

12. A proximity sensor control system in a land vehicle for selecting and actuating a proximity sensor on a selected side of the land vehicle to detect and warn of a hazardous lateral proximity between said land vehicle in forward motion and an external obstacle, so as to improve the safety of lateral merges, wherein the land vehicle is equipped with right and left directional signal lights respectively on right and left sides of the land vehicle, a directional signal selector switch arranged to select the right or left side directional signal lights, a source of relatively constant current, and a source of intermittent current, comprising:
a right side proximity sensor on the right side of said land vehicle;
a left side proximity sensor on the left side of the land vehicle; and
wherein said directional signal selector switch is connected to said source of relatively constant current and to said source of intermittent current and is moveable from a neutral position to either a first selection position or a second selection position; and
the directional signal selector switch is connected to said right side proximity sensor such that when the directional signal selector switch is in said first selection position, said intermittent current source is connected to said directional signal lights on the right side of the vehicle, and said relatively constant current source is connected to said proximity sensor on the right side of the vehicle, actuating the right side sensor; and
the directional signal selector switch is connected to said left side proximity sensor such that when the directional signal selector switch is in said second selection position, the intermittent current source is connected to the directional signal lights on the left side of the vehicle, and the relatively constant current source is connected to said proximity sensor on the left side of the vehicle, actuating the left side sensor.
